(19) United States
(12) Patent Application Publication
(10) Pub. No.: US 2006/0244682 A1
(43) Pub. Date: Nov. 2, 2006

(54) Arrangement for two-dimensional or three-dimensional representation

(76) Inventors: Thomas Brueggert, Jena (DE); Ingo Relke, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/553,248

(22) PCT Filed: Apr. 15, 2004
(86) PCT No.: PCT/EP04/03961

§ 371 Date: Oct. 17, 2005

(30) Foreign Application Priority Data
Apr. 16, 2003 (DE) 103 18 258.6

(51) Int. Cl. G09G 3/16

(52) U.S. Cl. 345/48; 359/475

(57) ABSTRACT

The invention relates to arrangements for the display of images of a scene or object, that alternatively provides either a three-dimensional or plain two-dimensional visual appearance to several viewers without any aids. In particular, the invention relates to an arrangement comprising a transflective image display device, a plane wavelength filter array arranged behind the image display device (in a viewer's viewing direction), and an illuminator arranged behind the wavelength filter array (in a viewer's viewing direction), in which, in a first mode of operation, light of the illuminator reaches the viewer passing through at least a share of the light-transparent filter elements and subsequently through a share, assigned to them, of the pixels of the image display device, so that the scene or object is visible to the viewer in three dimensions, and, in a second mode of operation, light incident on the front side of the image display device is used, thanks to the transflective properties of the latter, to illuminate it as homogeneously as possible, so that at least part of the scene or object is visible to the viewer in two dimensions.

### FIELD OF THE INVENTION

The invention relates to arrangements for the display of images of a scene or object, especially to such that alternatively provide either a three-dimensional or plain two-dimensional visual appearance to one or several viewers without any aids such as, for example, filter goggles.

### DESCRIPTION OF PRIOR ART

In the course of research in the field of autostereoscopic display, a great number of methods and arrangements have been developed, which give impressions of space to one or several viewers with unaided eyes. These arrangements, however, frequently allow but a limited presentation of common text or two-dimensional graphs, which is the case, e.g., with U.S. Pat. No. 5,457,574 and U.S. Pat. No. 5,606,455.

For users it is of advantage, though, if they can switch between 3D display not requiring special eyeglasses, and high-resolution, least-impaired 2D display on one and the same device.

To achieve this, a number of approaches exist. In the present applicant's WO 01/56265, for example, a method for spatial display is described in which at least one wavelength filter array provides 3D display. In a special embodiment of this invention, an LCD panel acts as a wavelength filter array with variable transmittance. This provides switching between 2D and 3D display. As a disadvantage, though, the light has to penetrate two LCD panels, i.e. through a great number of polarizing filters, color filters, liquid crystal layers and other component parts such as carrier substrates, so that brightness is reduced in both 2D and 3D display.

U.S. Pat. No. 5,897,184 suggests an autostereoscopic display with a reduced-thickness illumination module for portable computer systems, which allows switching from 3D to 2D and vice versa. In the 3D mode, this display has the following disadvantages: It is a display for a single viewer; to provide some freedom of movement for the viewer, the arrangement would require a complex tracking system, which could not implemented because of the main component of that arrangement. Moreover, the viewer will see strong moiré effects from all viewing positions except the one prescribed.

In the 2D mode, among other functions, the light available for the 3D mode is dispersed with the aim to undo the 3D image separation by homogenizing the illumination. In arrangements with a switchable diffusion disk, this results in a reduction of image brightness in the 2D mode compared to the 3D mode, because the dispersive state of such diffusion disks has a transmittance of less than 1. Besides, manufacturing the device takes much effort and cost.

The present applicant's DE 10053868 C2 describes an arrangement allowing the choice of 2D or 3D display by means of an illuminating device suitable for the respective display mode, this illuminating device being arranged behind an image display. The disadvantage of this arrangement is that the luminance available for 2D illumination cannot be made sufficiently homogeneous. Moreover, if a commercial light guide is used for 2D illumination, its macroscopic structure is visible to the viewer or viewers, as a rule, creating a disturbing moiré pattern, whereas an invisible microscopic structure is difficult and expensive to manufacture.

### DESCRIPTION OF THE INVENTION

Based on the prior art described, it is the purpose of the present invention to create an arrangement that allows at least one viewer, but preferably several viewers, to have a spatial view with unaided eyes in a 3D mode, and to see bright, fully resolved images in a 2D mode. Further, this arrangement is intended to be implementable using commercially available components to the greatest possible extent.

The problem is solved by an arrangement for the display of images of a scene or object,
comprising a transflective image display device consisting of a great number of picture elements (pixels) which are arranged in a matrix array of rows and/or columns, and on which image information from several perspective views of the scene or object can be displayed,
and further comprising a plane wavelength filter array that is arranged behind the image display device (in a viewer's viewing direction) and that consists of a great number of filter elements arranged in rows and/or columns, part of which are opaque, and the remaining part are transparent to light of specified wavelength ranges,
and further comprising an illuminator, preferably planar, arranged behind the wavelength filter array (in a viewer's viewing direction),
and in which, in a first mode of operation, light of the illuminator reaches the viewer passing through at least a share of the light-transparent filter elements and subsequently through a share, assigned to them, of the pixels of the image display device, so that the scene or object is visible to the viewer in three dimensions,
and in which, in a second mode of operation, light incident on the front side of the image display device is used, thanks to the transflective properties of the latter, to illuminate it as homogeneously as possible, so that at least part of the scene or object is visible to the viewer in two dimensions.

The term “transflective image display device” also includes such image display devices that, as a rule, are illuminated on the rear side for image display, but are provided with means for utilizing light incident on the front side. This is the case, for example, in an LCD panel the illumination-side polarizing filter is provided with a partially reflecting surface, so that light incident on the front side is reflected back.

Preferably, a second illuminator is provided to enhance the light incident on the front side of the image display device; this second illuminator emits light on the front side of the image display device. This ensures that the arrangement according to the invention can be used in the second mode of operation even in case of low ambient light.

The said second illuminator may be a planar illuminator designed as a plate-shaped light guide, which receives light from one or several, laterally arranged light sources. In this embodiment, the arrangement according to the invention can also be used in the first mode of operation, since the light originating from the first illuminator, which has penetrated the filter array and the image display device, can then also pass the light guide without being significantly influenced. This kind of second illuminator, then, is essentially transparent to light coming from the first illuminator.

In another advantageous embodiment, either parts of the second illuminator belong to a touch screen, or a touch screen is attached in front of the second illuminator or the image display device (in the viewing direction). Such a touch screen distinctly enhances the user interaction capability of the arrangement. It is feasible also to use an arrangement for non-contacting detection of the finger position instead of a touch screen.

Further, it is of advantage if, in the second mode of operation, the illuminating device arranged behind the wavelength filter array is switched off or dimmed down. This feature is intended to homogenize the light used for two-dimensional display.

In addition, the arrangement according to the invention preferably comprises a computing device for controlling the image display device and the illuminator or illuminators provided. This can be a microcomputer, for example. The latter version is particularly favorable if the arrangement according to the invention is part of a so-called “hand-held PC” or the like, such as a PDA or palm-top PC. Such small computers are often provided with transflective image display devices anyhow, so that the arrangement according to the invention can be integrated very easily.

The problem of the invention is also solved by an arrangement for the display of images of a scene or object,
comprising an image display device consisting of a great number pixels that are arranged in a matrix array of rows and/or columns, and on which image information from several perspective views of the scene or object can be displayed,
and further comprising a wavelength filter array consisting of a great number of filter elements arranged in rows and/or columns, part of which are transparent to light of specified wavelength ranges, and the remaining part are opaque,
and further comprising a light source, preferably planar, arranged behind the image display device (in a viewer's viewing direction),
and in which the wavelength filter array, in a first position, is arranged in front of the image display device (in a viewer's viewing direction), so that light reaches the viewer passing through at least part of the pixels of the image display device and subsequently through a share, assigned to them, of the light-transparent filter elements, so that the scene or object is visible to the viewer in three dimensions,
and in which the wavelength filter array, in a second position, is not arranged in front of the image display device (in a viewer's viewing direction), so that the light reaches the viewer passing through at least part of the pixels of the image display device, but subsequently not through light-transparent filter elements, so that the scene or object is visible to the viewer in two dimensions.

Furthermore, the wavelength filter array may, in a second position, be arranged partly in front of, and partly not in front of, the image display device (in a viewer's viewing direction), so that only part of the light reaches the viewer through at least part of the pixels of the image display device but subsequently not through light-transparent filter elements, so that only part of the scene or object is visible to the viewer in two dimensions.

Preferably, the wavelength filter array can be moved to reach the two positions. For that purpose, the wavelength filter array (and also its substrate material, if any) is flexible, so that the wavelength filter array can be bent. Preferably, the wavelength filter array can be moved around at least part of the image display device. In a favorable version, the wavelength filter array is displaced between the said first and second positions on one or several rails.

It is also feasible, for example, that the wavelength filter array, in its first position, is arranged between the image display device and the illuminating device. In this way it is possible also to achieve a very good 3D impression.

To make the arrangement as user-friendly as possible, the wavelength filter array is mechanically coupled to a knob that can be gripped and shifted by the user. In this way, the user merely needs to shift the said knob and, with it, the wavelength filter array back and forth between the two positions in order to switch between a two-dimensional and a three-dimensional display. Additional positions of the filter array providing a partially two-dimensional and partially three-dimensional display may be provided as well.

The problem of the invention is also solved by an arrangement for the display of images of a scene or object,
comprising an image display device consisting of a great number of pixels that are arranged in a matrix array of rows and/or columns, and on which image information from several perspective views of the scene or object can be displayed,
and further comprising a wavelength filter array that is arranged in front of or behind the image display device (in a viewers viewing direction), and that consists of a great number of filter elements arranged in rows and/or columns, part of which are transparent to light of specified wavelength ranges, while the remaining part are opaque, with at least every tenth filter element having photochromic, color-changing properties,
and in which, in a first mode of operation, especially due to a first state of the photochromic, color-changing filter elements, the wavelength filter array acts in such a way that light either passes first through filter elements and subsequently through the image display device, or first through, or out of, the image display device and subsequently through filter elements, so that the scene or object is visible to the viewer in three dimensions,
and in which, in a second mode of operation, especially due to a second state of the photochromic, color-changing filter elements, the wavelength filter array acts in such a way that light either passes first through filter elements and subsequently through the image display device, or first through, or out of, the image display device and subsequently through filter elements, so that the scene or object is visible to the viewer at least partially in two dimensions.

Preferably, not only every tenth filter element but all those filter elements to be used in the first mode of operation as essentially opaque to visible light are of the photochromic color-changing type.

Preferably, this third embodiment of the arrangement according to the invention also comprises at least one UV lamp, switching on of which produces the second state of the photochromic, color-changing filter elements, and switching off of which produces the first state of the photochromic, color-changing filter elements. In the second state, the photochromic, color-changing filter elements have a distinctly increased light transmittance; therefore, the second state, or the second mode of operation of the arrangement according to the invention, is suitable for two-dimensional display.

The at least one UV lamp may be arranged behind the wavelength filter array (in the viewing direction), or integrated in a planar illuminator arranged behind the image display device. It is also feasible that the at least one UV lamp is arranged in front of or beside the wavelength filter array if this is arranged in front of the image display device (in the viewing direction).

In the third embodiment of the arrangement according to the invention, the filter action in the first or second state of the photochromic, color-changing filter elements may be provided, for example, as follows:
essentially opaque to the visible spectrum,
essentially transparent to the visible spectrum,
transparent to red, green, blue, yellow, magenta, or cyan light.

Other filter actions are just as well possible, of course.

The arrangement according to the invention can further be implemented in that the image display device comprises a projection apparatus. Image display devices of other kinds, such as TFT-LCDs or plasma screens, can be used as well.

An embodiment that comprises a projection apparatus preferably includes at least two wavelength filter arrays, with at least every tenth filter element of each wavelength filter array having photochromic, color-changing properties, and with at least one wavelength filter array being arranged on the projection side of a projection screen. A rule for dimensioning and structuring the filter arrays is given in the present applicant's DE 20211612 U.

Finally, the problem of the invention is solved by an arrangement for the display of images of a scene or object,
comprising an image display device consisting of a great number of pixels that are arranged in a matrix array of rows and/or columns, and on which image information from several perspective views of the scene or object can be displayed,
and further comprising a wavelength filter array that is, in a first mode of operation, arranged in front of or behind the image display device (in a viewer's viewing direction), and that consists of a great number of filter elements arranged in rows and/or columns, part of which are transparent to light of specified wavelength ranges, whereas the remaining filter elements are opaque to light,
and in which the wavelength filter array in the first mode of operation acts in such a way that light either passes first through filter elements and subsequently through the image display device, or first through, or out of, the image display device and subsequently through filter elements, so that the scene or object is visible to the viewer in three dimensions,
and in which the wavelength filter array, in a second mode of operation, is replaced by a substrate that is largely transparent to visible light, so that the scene or object is visible to the viewer at least partially in two dimensions.

In the last-described embodiment of the arrangement according to the invention, the image display device is, with particular preference, a plasma screen. Furthermore, the substrate may be an electrically conductive, transparent pane of glass, PMMA or some laminate.

In such an arrangement, switching between the first and second modes of operation can be effected by mechanical displacement of the wavelength filter array or the substrate; preferably, in one of the two modes of operation, either the wavelength filter array and/or the substrate is/are intermediately held in a cassette.

### BRIEF DESCRIPTION OF THE DRAWINGS

Below, the invention is described in detail with reference to the accompanying drawings, in which:

FIG. 1 is a sketch illustrating the principle of the design of a first embodiment of the arrangement according to the invention,

FIG. 2 is a sketch illustrating the principle of the design of the first embodiment of the arrangement according to the invention, in the first mode of operation,

FIG. 3 is a sketch illustrating the principle of the design of the first embodiment of the arrangement according to the invention, in the second mode of operation,

FIG. 4 is a sketch illustrating the principle of the design of a second embodiment of the arrangement according to the invention, in the first mode of operation,

FIG. 5 is a sketch illustrating the principle of the design of the second embodiment of the arrangement according to the invention, in the second mode of operation,

FIG. 6 is a sketch illustrating the principle of the design of a third embodiment of the arrangement according to the invention in the first mode of operation,

FIG. 7 is a sketch illustrating the principle of the design of the third embodiment of the arrangement according to the invention, in the second mode of operation,

FIG. 8 is a sketch illustrating the principle of the design of a fourth embodiment of the arrangement according to the invention, in the first mode of operation, and

FIG. 9 is a sketch illustrating the principle of the design of the fourth embodiment of the arrangement according to the invention, in the second mode of operation.

### DETAILED DESCRIPTION OF THE DRAWINGS

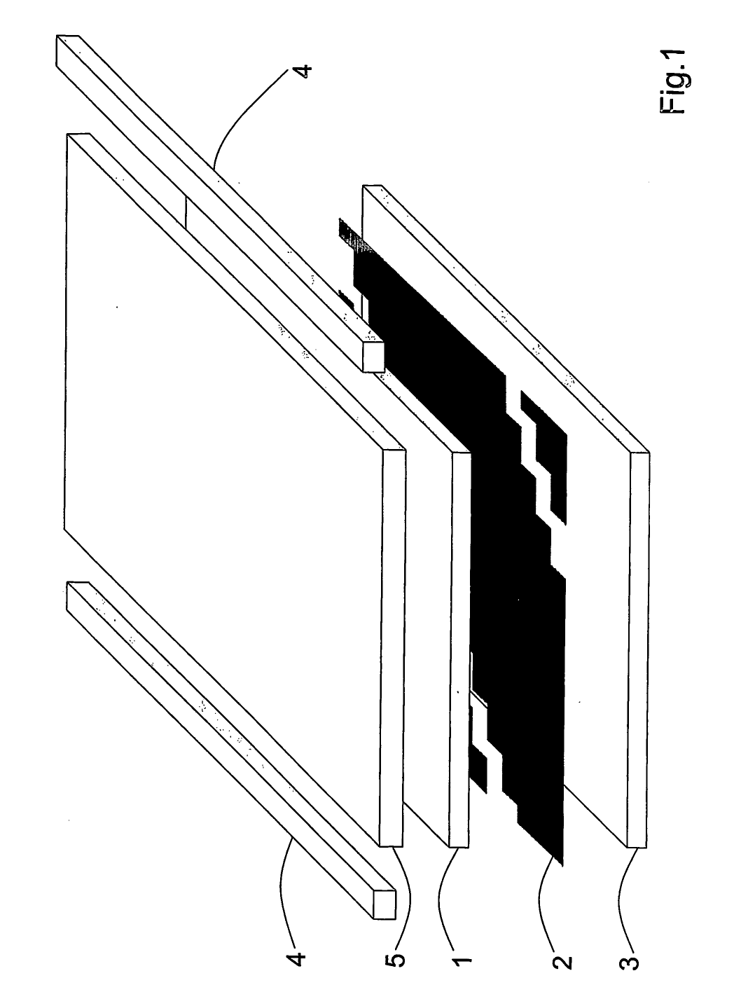

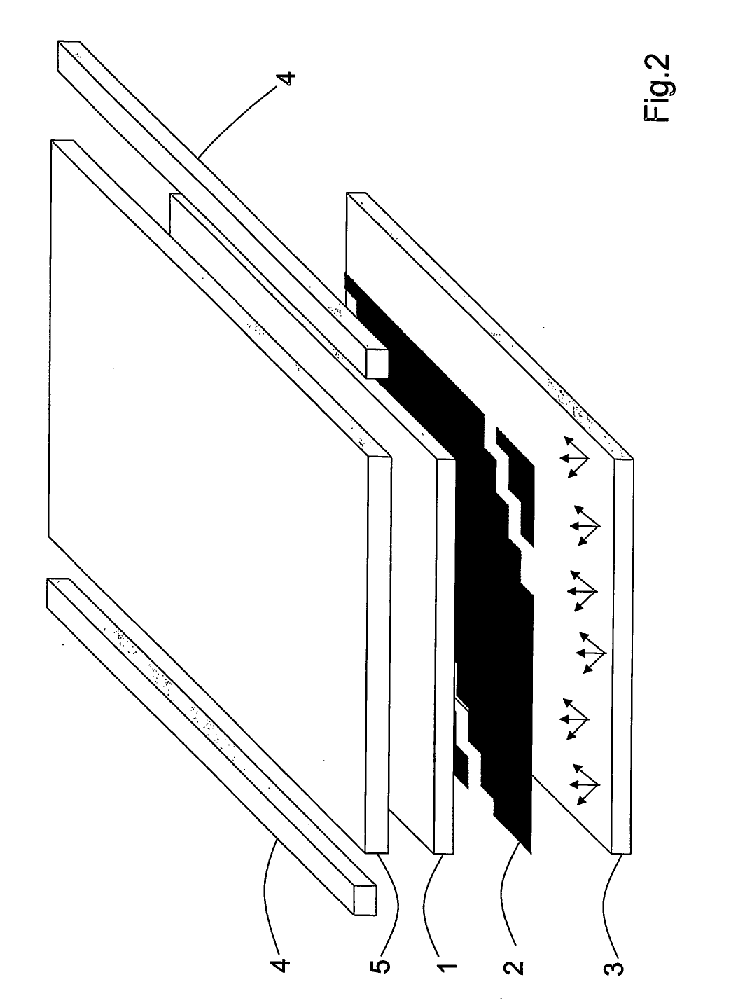

FIG. 1 is a sketch illustrating the principle of the design of a first embodiment of the arrangement according to the invention, for the display of images of a scene or object,
comprising a transflective image display device 1 consisting of a great number of picture elements (pixels) which are arranged in a matrix array of rows and/or columns, and on which image information from several perspective views of the scene or object can be displayed,
and comprising a plane wavelength filter array 2 that is arranged behind the image display device 1 (in a viewer's viewing direction) and that consists of a great number of filter elements arranged in rows and/or columns, part of which are opaque, and the remaining part are transparent to light of specified wavelength ranges,
and further comprising an illuminator 3, preferably planar, arranged behind the wavelength filter array 2 (in a viewers viewing direction),
and in which, in a first mode of operation (see FIG. 2), light of the illuminator 3 reaches the viewer passing through at least a share of the light-transparent filter elements and subsequently through a share, assigned to them, of the pixels of the image display device 1, so that the scene or object is visible to the viewer in three dimensions,
and in which, in a second mode of operation, light incident on the front side of the image display device 1 is used, thanks to the transflective properties of the latter, to illuminate it as homogeneously as possible, so that at least part of the scene or object is visible to the viewer in two dimensions.

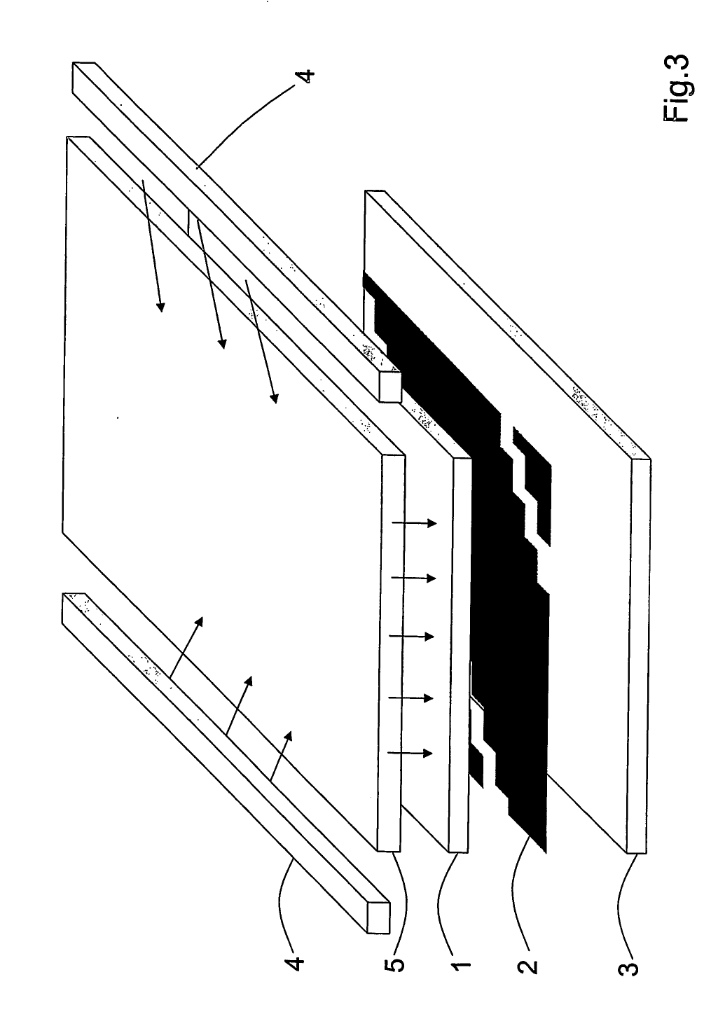

Preferably, a second illuminator is provided to enhance the light incident on the front side of the image display device 1; this second illuminator emits light on the front side of the image display device 1 (see FIG. 3). This ensures that the arrangement according to the invention can be used in the second mode of operation even in case of low ambient light.

The said second illuminator may be a planar illuminator designed as a plate-shaped light guide 5, which receives light from one or several, laterally arranged, preferably rod-shaped light sources 4. In this embodiment, the arrangement according to the invention can, without problems, be used in the first mode of operation, since the light originating from the first illuminator 3, which has penetrated the wavelength filter array 2 and the image display device 1, can then also pass the light guide 5 without being significantly influenced. This kind of second illuminator, then, is essentially transparent to light coming from the first illuminator 3.

In another advantageous embodiment, either parts of the second illuminator, especially the light guide 5, belong to a touch screen, or a touch screen is attached (in viewing direction) in front of the second illuminator, especially in front of, or immediately on, the light guide 5, or in front of the image display device, especially if no light guide 5 were provided.

Further, it is of advantage if, in the second mode of operation, the illuminating device 3 arranged behind the wavelength filter array 2 is switched off or dimmed down. This feature is intended to homogenize the light used for two-dimensional display.

Further, the arrangement according to the invention comprises a computing device for controlling the image display device 1 and the respective illuminator 3, 4, 5 provided. This computing device is not shown on the drawing; it can be a microcomputer, for example. The latter version is particularly relevant to applications if the arrangement according to the invention is part of a so-called “hand-held PC” or the like, such as a PDA or palm-top PC. Such small computers are often provided with transflective image display devices anyhow, so that the arrangement according to the invention can be integrated very easily.

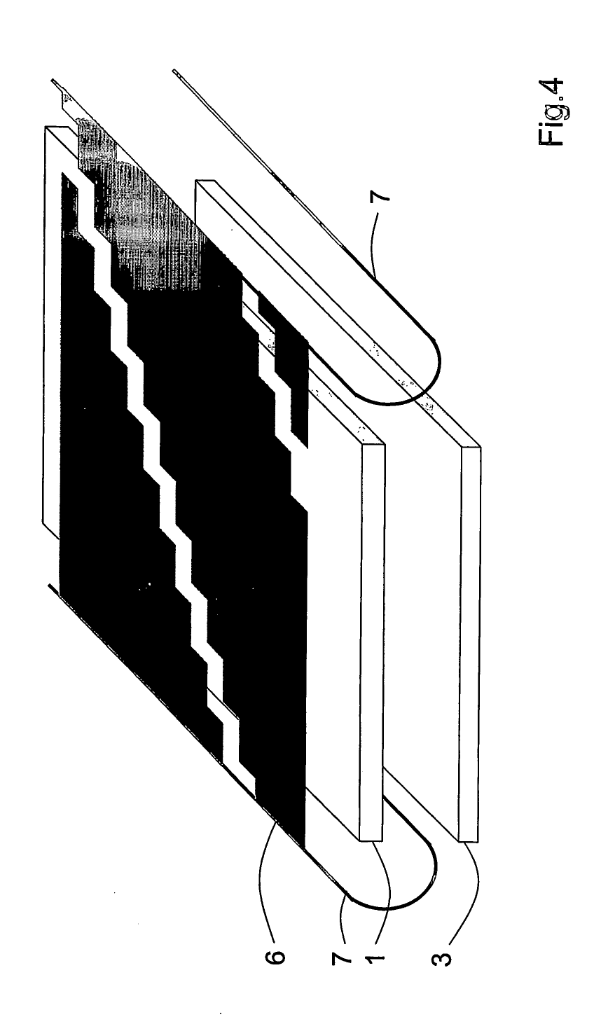

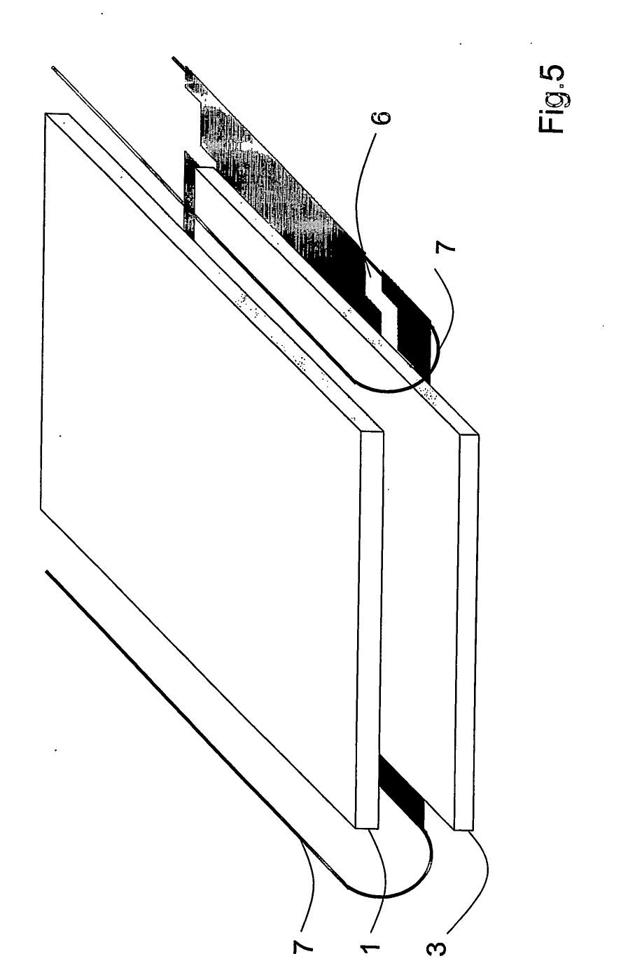

Die FIG. 4 is a sketch illustrating the principle of the design of a second embodiment of the arrangement according to the invention in the first mode of operation, whereas FIG. 5 shows the same embodiment in the second mode of operation. It is an arrangement for the display of images of a scene or object
comprising an image display device 1 consisting of a great number pixels that are arranged in a matrix array of rows and/or columns, and on which image information from several perspective views of the scene or object can be displayed,
and further comprising a wavelength filter array 6 consisting of a great number of filter elements arranged in rows and/or columns, part of which are transparent to light of specified wavelength ranges, and the remaining part are opaque,
and further comprising an illuminating device 3, preferably a planar illuminator, arranged behind the image display device 1 (in a viewers viewing direction),
and in which the wavelength filter array 6, in a first position illustrated as an example in FIG. 4, is arranged in front of the image display device 1 (in a viewer's viewing direction), so that light reaches the viewer passing through at least part of the pixels of the image display device 1 and subsequently through a share, assigned to them, of the light-transparent filter elements, which makes the scene or object visible to the viewer in three dimensions,
and in which the wavelength filter array 6, in a second position illustrated as an example in FIG. 5, is not arranged in front of the image display device 1 (in a viewers viewing direction), so that the light reaches the viewer passing through at least part of the pixels of the image display device 1, but subsequently not through light-transparent filter elements of the wavelength filter array 6, so that the scene or object is visible to the viewer in two dimensions.

Furthermore, the wavelength filter array 6 may, in a second position, be arranged partly in front of, and partly not in front of, the image display device 1 (in a viewers viewing direction), so that only part of the light reaches the viewer through at least part of the pixels of the image display device 1 but subsequently not through light-transparent filter elements, so that only part of the scene or object is visible to the viewer in two dimensions.

It is also possible, by the way, to use self-luminous image display devices, in which case the illuminating device 3 would be dropped.

Preferably, the wavelength filter array 6 can be moved to reach the two positions. For that purpose, the wavelength filter array 6 (and also its substrate material, if any) is flexible, so that the wavelength filter array 6 can be bent. The wavelength filter array 6 could consist, for example, of a piece of exposed and developed photographic film. Preferably, the wavelength filter array 6 can be moved around at least part of the image display device 1.

In a conveniently implementable version, the wavelength filter array 6 is displaced between the said first and second positions on one or several rails 7.

To make the arrangement as user-friendly as possible, the wavelength filter array 6 is mechanically coupled to a knob that can be gripped and shifted by the user. Such a knob is not shown on the drawings. In this way, the user merely needs to shift the said knob and, with it, the wavelength filter array 6 back and forth between the two positions in order to switch between a two-dimensional and a three-dimensional display. Additional positions of the filter array 6 providing a partially two-dimensional and partially three-dimensional display may be provided as well.

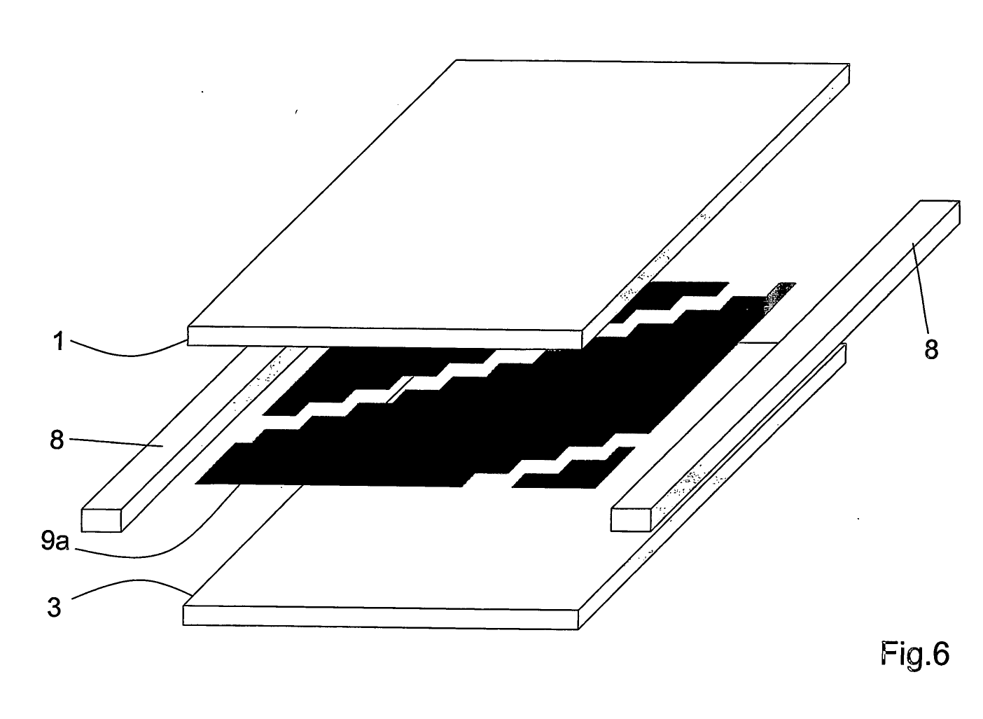

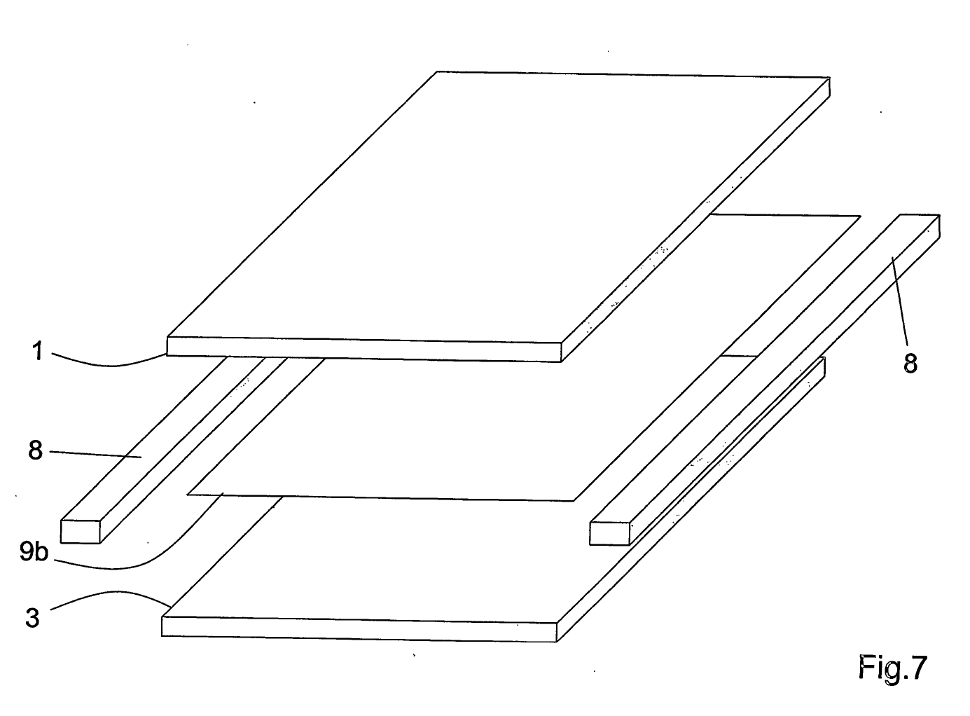

FIG. 6 is a sketch illustrating the principle of the design of a third embodiment of the arrangement according to the invention in the first mode of operation, whereas FIG. 7 shows the same embodiment in the second mode of operation. It is an arrangement for the display of images of a scene or object
comprising an image display device 1 consisting of a great number of pixels that are arranged in a matrix array of rows and/or columns, and on which image information from several perspective views of the scene or object can be displayed,
and further comprising a wavelength filter array 9a, 9b that is arranged in front of or behind the image display device 1 (in a viewers viewing direction), and that consists of a great number of filter elements arranged in rows and/or columns, part of which are transparent to light of specified wavelength ranges, while the remaining part are opaque, with at least every tenth filter element having photochromic, color-changing properties,
and in which, in a first mode of operation (see FIG. 6), especially due to a first state of the photochromic, color-changing filter elements, the wavelength filter array 9a acts in such a way that light either passes first through filter elements and subsequently through the image display device 1, or first through, or out of, the image display device 1 and subsequently through filter elements, so that the scene or object is visible to the viewer in three dimensions,
and in which, in a second mode of operation (see FIG. 7), especially due to a second state of the photochromic, color-changing filter elements, the wavelength filter array 9b acts in such a way that light either passes first through filter elements and subsequently through the image display device 1, or first through, or out of, the image display device 1 and subsequently through filter elements, so that the scene or object is visible to the viewer at least partially in two dimensions.

Preferably, this third embodiment also comprises at least one UV lamp 8. In the embodiments illustrated in FIG. 6 and FIG. 7, two UV lamps 8 are provided each. Switching the UV lamps 8 on produces the second state of the photochromic, color-changing filter elements, and switching them off produces the first state of the photochromic, color-changing filter elements. In the second state, the photochromic, color-changing filter elements have a distinctly increased light transmittance, wherefore the second state, or the second mode of operation of the arrangement according to the invention, is suitable for two-dimensional display.

As shown in FIG. 6 and FIG. 7, the UV lamps 8 are arranged, for example, beside the wavelength filter array 9a, 9b. When the UV lamps 8 are switched on, the light reaches the wavelength filter array 9b, which then adopts the second state of the photochromic, color-changing filter elements. Of course it is also possible to provide, in addition, reflectors for better utilization of the UV light (not shown on the drawings).

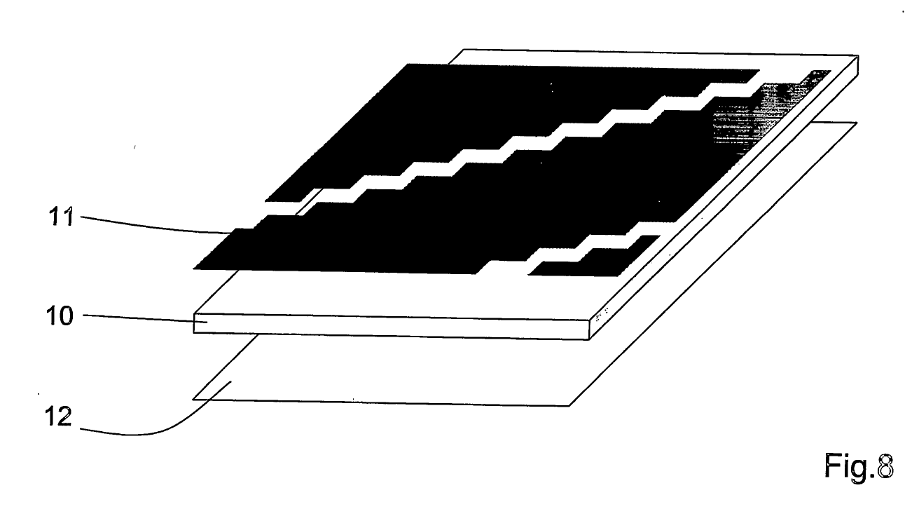

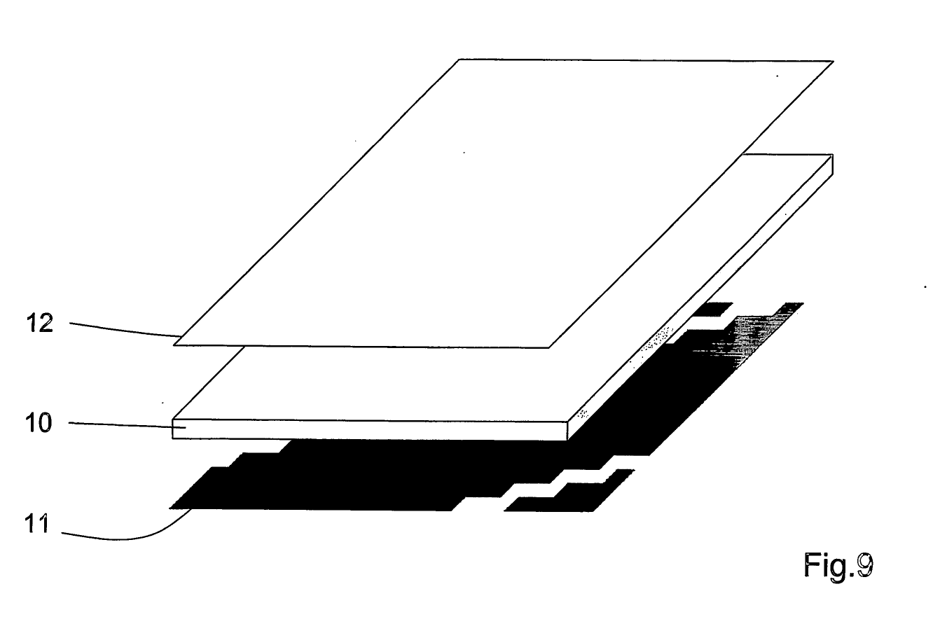

FIG. 8 is a sketch illustrating the principle of the design of a fourth embodiment of the arrangement according to the invention in the first mode of operation, whereas FIG. 9 shows the same embodiment in the second mode of operation. This is an arrangement for the display of images of a scene or object
comprising an image display device 10 consisting of a great number of pixels that are arranged in a matrix array of rows and/or columns, and on which image information from several perspective views of the scene or object can be displayed,
and further comprising a wavelength filter array 11 that is, in a first mode of operation, arranged in front of or behind the image display device 10 (in a viewers viewing direction), and that consists of a great number of filter elements arranged in rows and/or columns, part of which are transparent to light of specified wavelength ranges, whereas the remaining filter elements are opaque to light,
and in which the wavelength filter array 11 in the first mode of operation (see FIG. 8) acts in such a way that light either passes first through filter elements and subsequently through the image display device 10, or first through, or out of, the image display device 10 and subsequently through filter elements, so that the scene or object is visible to the viewer in three dimensions,
and in which the wavelength filter array 11, in a second mode of operation (see FIG. 9), is replaced by a substrate 12 that is largely transparent to visible light, so that the scene or object is visible to the viewer at least partially in two dimensions.

In the last-described embodiment of the arrangement according to the invention, the image display device 10 is, with particular preference, a plasma screen. Furthermore, the substrate 12 may be an electrically conductive, transparent pane of glass, PMMA or some laminate.

This arrangement is preferably characterized in that switching between the first and second modes of operation is effected by mechanical displacement of the wavelength filter array 11 or the substrate 12; preferably, in one of the two modes of operation, either the wavelength filter array 11 and/or the substrate 12 is/are intermediately held in a cassette.

It is within the scope of the invention to design the respective wavelength filter array and the 3D images to be displayed according to the teaching disclosed in WO 03/024122, by which at least one picture element is simultaneously assigned image information from two different views of a scene or object.

In all four embodiments of the invention, wavelength or gray level filter arrays known in prior art can be used. Regarding the fabrication, dimensioning and structuring of filter arrays and appropriate image combination rules for the images that can be displayed by the respective image display device, reference is made, for example, to the present applicant's WO 01/56265 and DE 201 21 318 U. Of course, other embodiment versions are feasible as well.

As a matter of course, in the second mode of operation of each of the arrangements according to the invention, the image displayed should be a common two-dimensional one, either throughout or at least on partial areas of the image display device, rather than an image composed of several views.

Further, it should be noted that in some embodiments of the invention, especially the fourth one, it is possible also to use optical components other than a wavelength filter array for producing a spatial impression, such as lenticular screens or the like.

The invention has the advantage that autostereoscopic image display arrangements can be designed in such a way that a 2D mode with an essentially unimpaired 2D rendition of bright, fully resolved images can be switched on. Moreover, the arrangements according to the invention can largely be made using commercially available components.

1-24. (canceled)

25. An arrangement for the display of images of a scene or object comprising:
a transflective image display device having a front side and including a multiplicity of picture elements or pixels arranged in a matrix, with image information from several perspective views of a scene or object being displayed on the matrix;
a plane wavelength filter array arranged behind the image display device and containing a multiplicity of filter elements arranged in rows and/or columns, some of the filter elements being opaque, with the remaining filter elements being substantially transparent to light of specified wavelength ranges;
a light emitting illuminator arranged behind the wavelength filter array, the light emitted from the illuminator passing through at least a portion of the transparent filter elements and subsequently through an assigned portion of the pixels of the image display device, so that the scene or object is visible in three dimensions;
and wherein the light incident on the front side of the image display device is used, because of the transflective properties of the image display device, to illuminate the front side in a substantially homogeneous manner, so that at least part of the scene or object is visible in two dimensions.

26. The arrangement of claim 25, wherein a second illuminator emits light on the front side of the image display device, thereby enhancing the light incident on the front side of the image display device.

27. The arrangement of claim 26 wherein the second illuminator is a planar illuminator designed as a plate-shaped light guide, the light guide receiving light from one or more laterally arranged light sources.

28. The arrangement of claim 26, wherein portions of the second illuminator are part of a touch screen, or a touch screen is arranged in front of the second illuminator or in front of the image display device.

29. The arrangement of claim 25, wherein the illuminating device arranged behind the wavelength filter array is switched off or dimmed down.

30. The arrangement of claim 25 further comprising a computing device for controlling the image display device and the illuminator.

31. An arrangement for the display of images of a scene or object comprising:
an image display device including a plurality of pixels arranged in a matrix that displays image information from several perspective views of a scene or object;
a wavelength filter array containing a multiplicity of filter elements, wherein some of the filter elements are substantially transparent to light of specified wavelength ranges and a balance of the filter elements are opaque;
an illuminating device arranged behind the image display device; and
the wavelength filter array having a first and a second position,
the first position being in front of the image display device thereby causing light to pass through at least part of the pixels of the image display device and subsequently through an assigned share of the transparent filter elements and causing the scene or object to be visible in three dimensions,
the second position being not in front of the image display device, so that the light reaches the viewer passing through at least part of the pixels of the image display device, but subsequently not through the transparent filter elements of the wavelength filter array, so that at least part of the scene or object is visible to the viewer in two dimensions.

32. The arrangement of claim 31 wherein the illuminating device is a substantially planar illuminator.

33. An arrangement as claimed in claim 32, wherein the second position of the wavelength filter array is partly in front of and partly not in front of the image display device, so that only part of the light passes through at least part of the pixels of the image display device but not through substantially transparent filter elements, so that only part of the scene or object is visible to the viewer in two dimensions.

34. The arrangement of claim 32, wherein the first and second positions of the wavelength filter array are reached by a movement of the wavelength filter array.

35. The arrangement of claim 33, wherein the first and second positions of the wavelength filter array are reached by moving the wavelength filter array.

36. The arrangement of claim 32, wherein the wavelength filter array is flexible.

37. The arrangement of claim 33, wherein the wavelength filter array is flexible.

38. The arrangement of claim 37, wherein the wavelength filter array further comprises a flexible substrate.

39. The arrangement of claim 34, wherein movement of the wavelength filter array is guided at least partially around the image display device.

40. The arrangement of claim 32, wherein the wavelength filter array is shifted between the first and second positions on at least one rail.

41. The arrangement of claim 40, further comprising a knob connected to the wavelength filter array to shift the filter array.

42. An arrangement for the display of images of a scene or object, comprising:
an image display device having a front face and comprising a multiplicity of pixels arranged in a matrix array that displays image information from several perspective views of a scene or object;
a wavelength filter array having a front face and comprising a plurality of filter elements, the wavelength filter array arranged in front of or behind the image display device, each of the filter elements in the filter array being substantially transparent to light of specified wavelength ranges or substantially opaque, and wherein at least every tenth filter element has photochromic, color-changing properties;
wherein the wavelength filter array substantially passes or substantially blocks light first through the filter elements and subsequently through the image display device, or first through the image display device and subsequently through filter elements, and
wherein the photochromic, color-changing filter elements having a first state and a second state, the first state causing the scene or object to be visible in three dimensions, and the second state causing the scene or object to be visible in two dimensions.

43. The arrangement of claim 42, further comprising at least one ultraviolet light source configured to irradiate the photochromic, color-changing filter elements, wherein the irradiation causes the second state of the photochromic, color-changing filter elements.

44. The arrangement of claim 43, wherein the at least one ultraviolet light source is arranged behind the wavelength filter array.

45. An arrangement as claimed in claim 43, wherein the at least one ultraviolet light source is integrated in a planar illuminating device that is arranged behind the image display device.

46. The arrangement of claim 43, wherein the at least one ultraviolet light source is arranged in front of or beside the wavelength filter array, if this is arranged in front of the image display device.

47. The arrangement of claim 42, wherein a characteristic of each of the photochromic, color-changing filter elements in the first or second state is selected from the group consisting of essentially opaque to the visible spectrum, essentially transparent to the visible spectrum, substantially transparent to red light, substantially transparent to green light, substantially transparent to blue light, substantially transparent to yellow light, substantially transparent to magenta light, and substantially transparent to cyan light.

48. The arrangement of claim 42, wherein the image display device comprises a projection apparatus.

49. The arrangement of claim 48, further comprising:
a projection screen having a projection side;
at least two wavelength filter arrays, wherein at least every tenth filter element on each wavelength filter array has photochromic, color-changing properties, at least one wavelength filter array being arranged on the projection side of the projection screen.

50. An arrangement for the display of images of a scene or object, comprising
an image display device comprising a multiplicity of pixels arranged in a matrix, with image information from several perspective views of a scene or object being displayed thereupon; and
a wavelength filter array arranged in front of or behind the image display device, the filter array comprising a plurality of filter elements, each filter element being substantially transparent to light of specified wavelength ranges or substantially opaque to light,
the wavelength filter array having a first mode of operation wherein light passes first through the filter elements and then through the image display device, or first through the image display device and then through filter elements, causing the scene or object to be displayed in three dimensions, and
the wavelength filter array having a second mode of operation wherein the filter array is replaced by a substrate that is substantially transparent to visible light, causing the scene or object to be displayed at least partially in two dimensions.

51. The arrangement of claim 50, wherein the image display device is a plasma screen, and the substrate is an electrically conductive, substantially transparent pane of glass, PMMA or laminate.

52. The arrangement of claim 50, wherein switching between the first and second modes of operation is effected by mechanical displacement of the wavelength filter array or the substrate, and wherein, in one of the two modes of operation, either the wavelength filter array or the substrate are intermediately held in a cassette.
